(19) United States
(12) Patent Application Publication
(10) Pub. No.: US 2008/0145102 A1
(43) Pub. Date: Jun. 19, 2008

(54) Surface-moving-body driving device, belt device, and image forming apparatus

(75) Inventors: Tsutomu Katoh, Kanagawa (JP); Mitsuru Takahashi, Kanagawa (JP); Nobuto Yokokawa, Kanagawa (JP); Kazuosa Kuma, Kanagawa (JP); Takeshi Fukao, Kanagawa (JP); Yoshihiro Fujiwara, Kanagawa (JP); Yoshiharu Kishi, Tokyo (JP)

Correspondence Address: HARNESS, DICKEY & PIERCE, P.L.C., P.O. BOX 8910, RESTON, VA, 20195, US

(73) Assignee: RICOH COMPANY, LIMITED

(21) Appl. No.: 12/000,382

(22) Filed: Dec. 12, 2007

(30) Foreign Application Priority Data
Dec. 14, 2006 (JP) 2006-337405

(51) Int. Cl. G03G 15/00; F16H 37/02

(52) U.S. Cl. 399/167; 475/331

(57) ABSTRACT

A surface moving body includes an endless surface that is capable of making an endless movement. A surface-moving-body drive mechanism includes a driving source of a driving force for moving the surface moving body and a drive transmission mechanism for transmitting the driving force from the driving source to the surface moving body. At least a part of the surface-moving-body drive mechanism is arranged in a surface-moving-body occupying space surrounded by two surfaces defined by ends of the endless surface in a width direction orthogonal to a surface moving direction of the endless surface and the endless surface.

### CROSS-REFERENCE TO RELATED APPLICATIONS

The present application claims priority to and incorporates by reference the entire contents of Japanese priority document 2006-337405 filed in Japan on Dec. 14, 2006.

### BACKGROUND OF THE INVENTION

1. Field of the Invention

The present invention relates to a surface-moving-body driving device that includes a surface moving body and a surface-moving-body drive mechanism used in an image forming apparatus, a belt device that includes the surface-moving-body driving device, and the image forming apparatus that includes the surface-moving-body driving device or the belt device.

2. Description of the Related Art

An image forming apparatus includes for moving a surface, a plurality of surface moving bodies including an endless surface. From the plurality of the surface moving bodies, the surface moving body to be driven includes a surface-moving-body driving device including a driving source of a driving force by which the surface moving body moves the surface and a surface moving body drive transmission mechanism that transmits a drive from the driving source to the surface moving body.

As the surface-moving-body driving device included in a commonly used image forming apparatus, a rotating-body driving device is indicated in FIG. 8. The rotating-body driving device disclosed in Japanese Patent Application Laid-open No. H9-222826 includes as a rotating body that is the surface moving body, a photosensitive element.

As shown in FIG. 8, in the rotating-body driving device disclosed in a technology mentioned earlier, a driving shaft 35 that is a rotation center of a photosensitive drum 2 includes a photosensitive-element drive gear 41 towards outer side from an end of a width direction (in a drawing, left right direction) of the photosensitive drum 2. By smoothly engaging a motor shaft gear 40 and the photosensitive-element drive gear 41 included in a rotary shaft 39 of a driving motor 38, which is the driving source, a rotational driving force is transmitted from the driving motor 38 to the photosensitive drum 2. As shown in FIG. 8, in the rotating-body driving device disclosed in a technology mentioned earlier, a drive transmission mechanism formed of the motor shaft gear 40 and the photosensitive-element drive gear 41 and the driving motor 38, which is the driving source, are arranged towards outer side from the end of the width direction of the photosensitive drum 2.

In recent years, a request is made for a compact image forming apparatus, thus, a compact surface-moving-body driving device is desired. However, based on a usage purpose of the surface moving body, a peripheral length of a surface moving direction of an endless surface of the surface moving body or a length in the width direction orthogonal to the surface moving direction is determined. Thus, reducing the surface moving body is difficult. As shown in FIG. 8, in the commonly used surface-moving-body driving device, a surface-moving-body drive mechanism formed of the drive transmission mechanism and the driving source is arranged towards outer side from the end of the width direction of the surface moving body. In such a structure, as the length in the width direction of the surface-moving-body driving device, a length obtained by adding the length in the width direction of a space for arranging the surface-moving-body drive mechanism to the length in the width direction of the surface moving body is required. In other words, in addition to a surface-moving-body occupying space that is surrounded by two surfaces specified for each end of the width direction of the endless surface and the endless surface, a space for arranging the surface-moving-body drive mechanism is required.

In the commonly used surface-moving-body driving device to be arranged in a shaft direction independently from the surface-moving-body occupying space and the space for arranging the surface-moving-body drive mechanism, downsizing the surface-moving-body driving device with respect to the surface moving body of a predetermined size is very difficult.

### SUMMARY OF THE INVENTION

It is an object of the present invention to at least partially solve the problems in the conventional technology.

A surface-moving-body driving device according to one aspect of the present invention is used in an image forming apparatus. The surface-moving-body driving device includes a surface moving body including an endless surface that is capable of making an endless movement and a surface-moving-body drive mechanism including a driving source of a driving force for moving the surface moving body and a drive transmission mechanism for transmitting the driving force from the driving source to the surface moving body. At least a part of the surface-moving-body drive mechanism is arranged in a surface-moving-body occupying space surrounded by two surfaces defined by both ends of the endless surface in a width direction orthogonal to a surface moving direction of the endless surface and the endless surface.

A belt device according to another aspect of the present invention includes an endless belt and a plurality of extending members extending the endless belt. At least one extending member is a surface moving body of a surface-moving-body driving device. At least one surface-moving-body driving device includes a surface moving body including an endless surface that is capable of making an endless movement, and a surface-moving-body drive mechanism including a driving source of a driving force for moving the surface moving body and a drive transmission mechanism for transmitting the driving force from the driving source to the surface moving body. At least a part of the surface-moving-body drive mechanism is arranged in a surface-moving-body occupying space surrounded by two surfaces defined by both ends of the endless surface in a width direction orthogonal to a surface moving direction of the endless surface and the endless surface.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram for explaining a roller driving device according to a first embodiment;

FIG. 2 is a schematic diagram of an overview of a copier according to an embodiment of the present invention;

FIG. 3 is a schematic diagram of a gear;

FIG. 4 is a schematic diagram for explaining a photosensitive-element driving device;

FIG. 5 is a schematic diagram of an overview of a copier according to modifications;

FIG. 6 is a schematic diagram for explaining a roller driving device according to a second embodiment;

FIG. 7 is a schematic diagram for explaining a roller driving device according to a third embodiment; and

FIG. 8 is a schematic diagram of an overview of a rotating-body driving device disclosed in Japanese Patent Application Laid-open No. H9-222826.

### DETAILED DESCRIPTION OF THE PREFERRED EMBODIMENTS

Exemplary embodiments of the present invention are explained in detail below with reference to the accompanying drawings.

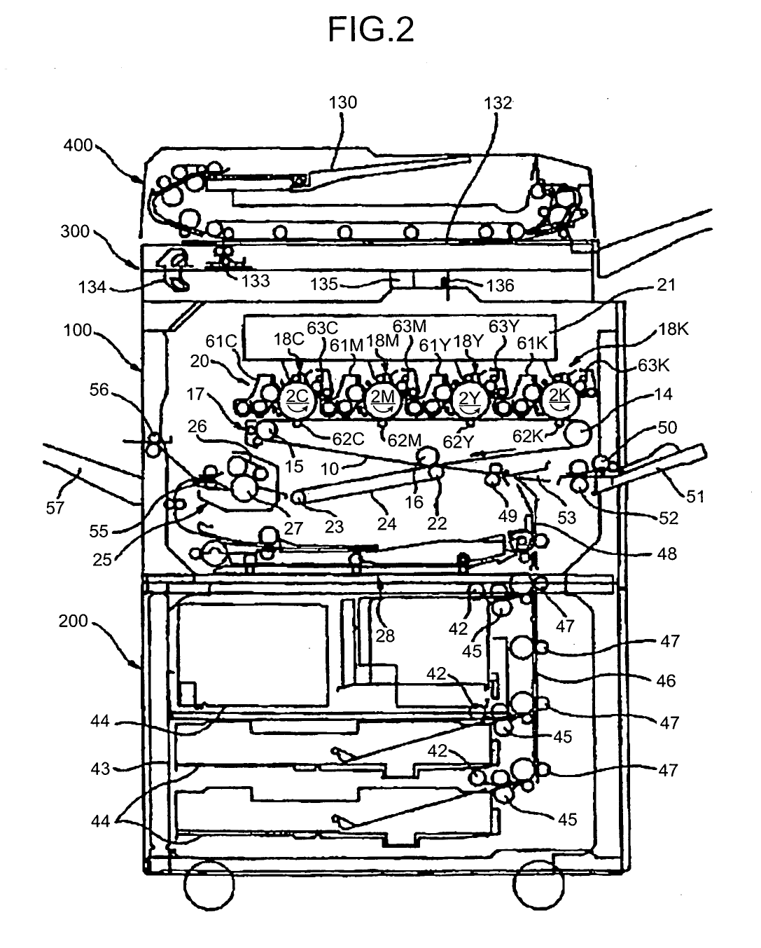

FIG. 2 is a schematic diagram of an overview of a copier that is an image forming apparatus according to an embodiment of the present invention. The copier includes a copying device main body (hereinafter, “a printer 100”), a sheet-feeding table (hereinafter, “a sheet feeder 200”), a scanner (hereinafter, “a scanner 300”) fixed to the printer 100, and an automatic document feeder (ADF) (hereinafter, “an ADF 400”) fixed to the scanner 300. Furthermore, the copier also includes a not shown controller for controlling operations of each device within the copier.

In the center, the printer 100 includes as an intermediate transfer body, an intermediate transfer belt 10. The intermediate transfer belt 10 is wound around a first supporting roller 14, a second supporting roller 15, and a third supporting roller 16, thereby enabling to move the surface in a clockwise direction. The printer 100 also includes as a photosensitive element that bears on the surface a respective toner image of one color from black, yellow, magenta, and cyan, four photosensitive drums 2K, 2Y, 2M, and 2C such that the photosensitive drums 2K, 2Y, 2M, and 2C mentioned earlier will be across the intermediate transfer belt 10. Developing units 61K, 61Y, 61M, and 61C are included for forming the toner image on the surface of the photosensitive drums 2K, 2Y, 2M, and 2C. Furthermore, photosensitive-element cleaning devices 63K, 63Y, 63M, and 63C are also included for removing a toner remaining on the surface of the photosensitive drums 2K, 2Y, 2M, and 2C after primary transfer. A tandem-type image forming unit 20 includes horizontally arranged four image forming units 18K, 18Y, 18M, and 18C formed of the photosensitive drums 2K, 2Y, 2M, and 2C, the developing units 61K, 61Y, 61M, and 61C, and the photosensitive-element cleaning devices 63K, 63Y, 63M, and 63C. A belt cleaning device 17 is included across the third supporting roller 16 such that the intermediate transfer belt 10 is sandwiched between the belt cleaning device 17 and the third supporting roller 16. The belt cleaning device 17 removes the toner remaining on the intermediate transfer belt 10 after transferring the toner image to a transfer sheet that is a recording medium. Furthermore, the printer 100 includes an exposing device 21 above the tandem-type image forming unit 20.

Inside the intermediate transfer belt 10, primary transfer rollers 62K, 62Y, 62M, and 62C are included in a position across the photosensitive drums 2K, 2Y, 2M, and 2C such that the intermediate transfer belt 10 is sandwiched between the primary transfer rollers 62K, 62Y, 62M, and 62C and the photosensitive drums 2K, 2Y, 2M, and 2C. The primary transfer rollers 62K, 62Y, 62M, and 62C push against the photosensitive drums 2K, 2Y, 2M, and 2C, the intermediate transfer belt 10, thereby forming a primary transfer unit.

A secondary transfer device is included on an opposite side of the tandem-type image forming unit 20 such that the intermediate transfer belt 10 is sandwiched between the secondary transfer device and the tandem-type image forming unit 20. The secondary transfer device is formed by passing a secondary transfer belt 24 between a secondary transfer roller 22 and a secondary transfer belt extending roller 23. The secondary transfer belt extending roller 23 is a driving roller of the secondary transfer belt 24 to which the driving force is transmitted from a not shown motor. In the secondary transfer device, at a position supported by the secondary transfer roller 22, the secondary transfer belt 24 is pushed against the third supporting roller 16 via the intermediate transfer belt 10. The secondary transfer device is arranged such that as a secondary transfer unit, a secondary transfer nip will be formed between the secondary transfer belt 24 and the intermediate transfer belt 10.

As shown in a drawing, a fixing device 25 that fixes transferred images on the transfer sheet is included on the left side of the secondary transfer device. The fixing device 25 pushes a pressure roller 27 against an endless fixing belt 26. The secondary transfer device mentioned earlier also includes a transfer sheet conveying function that conveys to the fixing device 25, the transfer sheet receiving a transferred toner image in the secondary transfer nip. Furthermore, a transfer roller or a non-contact charger can also be arranged as the secondary transfer device. However, when using the transfer roller or the non-contact charger as the secondary transfer device, it will be difficult to also include the transfer sheet feeding function.

A transfer-sheet reversing device 28, which reverses the transfer sheet when recording images on both sides, is included under the secondary transfer device and the fixing device 25, parallel to the tandem-type image forming unit 20 mentioned earlier. After fixing the image on one side of the transfer sheet, a track of the transfer sheet is switched to the transfer-sheet reversing device 28 side by a switching claw 55 and upon reversing the transfer sheet, the transfer sheet is again conveyed to the secondary transfer nip. Upon transferring the toner image, the transfer sheet can be collected in a catch tray.

The scanner 300 reads image data on documents placed on a contact glass 132 by a reading sensor 136 and sends the read image data to the controller.

Based on the image data received from the scanner 300, the not shown controller controls a not shown laser and a light-emitting diode (LED) fixedly set up in the exposing device 21 of the printer 100 and a laser writing light L is irradiated onto the photosensitive drum 2. Due to this, an electrostatic latent image is formed on the surface of the photosensitive drum 2 and the electrostatic latent image is developed into the toner image using a predetermined development process.

The sheet feeder 200 includes sheet feeding cassettes 44 included in multi-stages in a sheet bank 43, sheet feeding rollers 42 that render a transfer sheet P from the sheet feeding cassettes 44, separating rollers 45 that separate the rendered transfer sheet P and sends to a sheet feeding path 46, and conveying rollers 47 that convey the transfer sheet P to a sheet feeding path 48 of the printer 100.

In the copier according to the present embodiment, other than the sheet feeder 200, the sheet can be fed manually. The copier also includes on a side surface a manual tray 51 for feeding the sheet manually, a manual separating roller 52 that one by one separates the transfer sheet P arranged in the manual tray 51 for a manual sheet feeding path 53.

A registration roller 49 ejects only one transfer sheet P from the transfer sheet P placed on the sheet feeding cassettes 44 or the manual tray 51 and sends to the secondary transfer nip positioned between the intermediate transfer belt 10 as an intermediate transfer body and the secondary transfer device.

While taking a copy of a color image in the copier according to the present embodiment, the document is set on a document stand 130 in the ADF 400 or the ADF 400 is opened, the document is set on the contact glass 132 in the scanner 300 and the ADF 400 is closed to hold down the document.

If a not shown start switch is pressed, when the document is set in the ADF 400 and the document is conveyed to and is set on the contact glass 132, immediately after that the driving of the scanner 300 starts and the driving of a first carrier 133 and a second carrier 134 also starts. A light emits on the first carrier 133 from a light source and the light reflected from a document surface further reflects on the second carrier 134 through a mirror of the second carrier 134 and enters into the reading sensor 136 via an imaging lens 135 and the image data on the document is read.

Upon receiving the image data from the scanner 300, by executing the laser writing mentioned earlier or the development process mentioned later, the toner image is formed on the photosensitive drum 2 and one of the sheet feeding rollers performing the feeding of the transfer sheet P of the size according to the image data is activated.

Due to this, by a not shown driving motor, from the first supporting roller 14, the second supporting roller 15, and the third supporting roller 16, one supporting roller is rotatably driven and other two supporting rollers are driven rotated and the intermediate transfer belt 10 is rotatably conveyed. In the present embodiment, the driving motor rotatably drives the first supporting roller 14. At the same time, each image forming unit 18 rotates the photosensitive drum 2 and forms a monochromatic image of black, yellow, magenta, and cyan, respectively on the corresponding photosensitive drum 2. Along with a movement of the intermediate transfer belt 10, each monochromatic image is sequentially transferred and a composite color image is formed on the intermediate transfer belt 10.

However, in the sheet feeder 200, one of the sheet feeding rollers 42 is selectively rotated. The transfer sheet P is rendered from one of the sheet feeding cassettes 44. The transfer sheet P is one by one separated by the separating rollers 45 and is inserted into the sheet feeding path 46. The transfer sheet P is guided by the conveying rollers 47 to the sheet feeding path 48 in the printer 100 that is the copier main body and the transfer sheet P is stopped by striking against the registration roller 49 or by rotating a sheet feeding roller 50, the transfer sheet P placed in the manual tray 51 is rendered and upon one by one separated by the manual separating roller 52, inserted into the manual sheet feeding path 53 and in the same way, the transfer sheet P is stopped by striking against the registration roller 49. Furthermore, when using the transfer sheet P placed in the manual tray 51, the sheet feeding roller 50 is rotated and the transfer sheet P placed on the manual tray 51 is rendered. Upon the manual separating roller 52 one by one separating the transfer sheet P, the transfer sheet P is inserted into the manual sheet feeding path 53 and the transfer sheet P is stopped by striking against the registration roller 49.

The registration roller 49 is rotated in synchronization with the composite color image on the intermediate transfer belt 10 and the transfer sheet P is fed into the secondary transfer nip, which is a contact part between the intermediate transfer belt 10 and the secondary transfer roller 22. Due to effects of an electrical field for transfer and a contact pressure formed on the secondary transfer nip, a color image is secondarily transferred and is recorded on the transfer sheet P.

Upon the secondary transfer nip receiving the transferred color image, the transfer sheet P is fed into the fixing device 25 by the secondary transfer belt 24 of the secondary transfer device. The fixing device 25 applies a pressure and a heat by the pressure roller 27 and the fixing belt 26 and fixes the color image. The transfer sheet P is ejected by an ejecting roller 56 and is stacked on a catch tray 57. Upon fixing the color image on the transfer sheet P whereon the image is to be formed on the both sides, the transfer sheet P is switched by the switching claw 55 and is conveyed to the transfer-sheet reversing device 28. Upon reversal, the transfer sheet P is again guided to the secondary transfer nip and the image is recorded on a backside of the transfer sheet P and the transfer sheet P is ejected by the ejecting roller 56 in the catch tray 57.

After the color image is transferred on the transfer sheet P in the secondary transfer nip, the toner remaining on the surface of the intermediate transfer belt 10 is removed by the belt cleaning device 17 and the intermediate transfer belt 10 is again arranged for forming the image by the tandem-type image forming unit 20.

As shown in FIG. 2, a large number of roller members are used in the copier. Some of the roller members are the roller members that are the surface moving bodies included by a roller driving device that is the surface-moving-body driving device including the surface moving body and the surface-moving-body drive mechanism.

In recent years, due to changes in the usage environment such as usage in a small space and a desktop, a compact image forming apparatus is required. The image forming apparatus includes the large number of roller members a-s the surface moving bodies such as the conveying rollers 47 and the photosensitive bodies. A significant percentage of the roller drive mechanism is included in the device as the surface-moving-body drive mechanism such as a motor and a gear causing the roller members to drive. Recently, in the significantly used color image forming apparatus, as shown in FIG. 2, the intermediate transfer body is widely used and for driving the intermediate transfer body, a drive mechanism is necessary. In the tandem-type color image forming apparatus that can obtain an average output speed of monochrome, the drive mechanism is necessary for the respective photosensitive element of four colors, thus, the percentage of using the drive mechanism in the device is significantly increasing. For downsizing the image forming apparatus, downsizing of the surface-moving-body drive mechanism in the surface-moving-body driving device is desired.

A first embodiment of a structure, which indicates salient features of the present invention, is explained next.

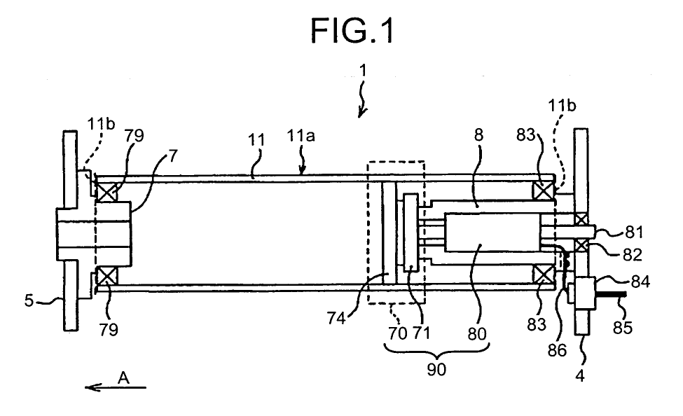

FIG. 1 is a schematic diagram for explaining a roller driving device as the surface-moving-body driving device according to the first embodiment. A horizontal direction in FIG. 1 indicates a front and back direction of a sheet surface in FIG. 2. An arrow A in FIG. 1 indicates a front direction in FIG. 2 and a front side of the copier.

As shown in FIG. 1, a roller driving device 1 includes as the surface moving body, a pipe-shaped roller member 11. The roller member 11 is held by a rear holder 8 via rear ball bearings 83 and is held by a front holder 7 via front ball bearings 79. Furthermore, because the rear holder 8 is fixed to a rear side plate 4 and the front holder 7 is fixed to a front side plate 5, the roller member 11 is held by the rear side plate 4 via the rear holder 8 and by the front side plate 5 via the front holder 7. Thus, a position of the roller member 11 is decided with respect to the rear side plate 4 and the front side plate 5. In the roller driving device 1 shown in FIG. 1, the rear ball bearings 83 and the rear holder 8 are rear side moving body support members and the front ball bearings 79 and the front holder 7 are front side moving body support members.

A planetary-gear supporting member 74, which is described later, is fixed inside the roller member 11 and an internal gear 71 is fixed to the rear holder 8. A motor 80, which is a driving source, is fixed to the rear holder 8. The rear side plate 4 holds via a drive rotational bearing 82, a rear side end of a motor shaft 81 that is a driving rotary shaft. The rotational driving force of the motor 80 is transmitted via the motor shaft 81 and a gear 70 that includes the internal gear 71 and the planetary-gear supporting member 74, thereby rotating the roller member 11.

The gear 70 as a drive transmission mechanism is explained next.

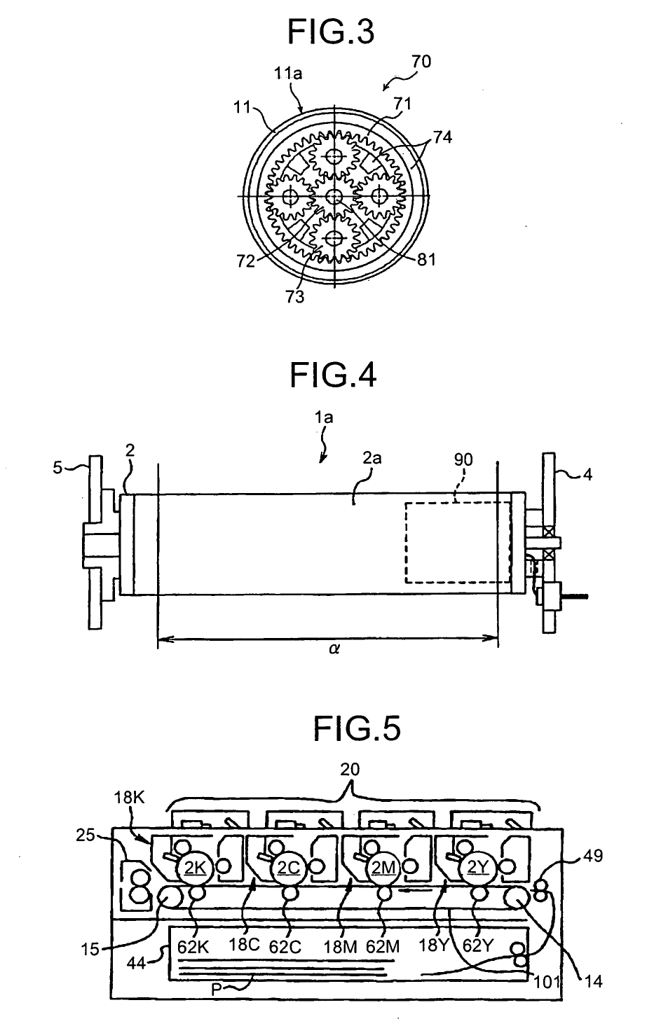

FIG. 3 is a schematic diagram of the gear 70 when viewed from a right side in FIG. 1.

As shown in FIG. 3, the gear 70 is a planetary gear mechanism. A sun gear 72 is fixed to a front end of the motor shaft 81 and four planetary gears 73 are arranged around the sun gear 72 such that the planetary gears 73 will mesh with the sun gear 72. Rotating shafts of the planetary gears 73 are fixed to the planetary-gear supporting member 74 and the internal gear 71 is arranged outside the planetary gears 73 such that the internal gear 71 will mesh with all the planetary gears 73. By driving the motor 80, the motor shaft 81 rotates and the sun gear 72 also rotates. The planetary gears 73 meshing with the sun gear 72 also rotate. However, the internal gear 71 meshing with the planetary gears 73 is fixed, thus, the rotating shafts of the planetary gears 73 receive a force to rotate according to the internal gear 71. Due to this, the driving force is transmitted to the planetary-gear supporting member 74, thereby rotatably driving the roller member 11 to which the planetary-gear supporting member 74 is fixed.

Even if the gear 70 shown in FIG. 3 is a planetarium-type planetary gear mechanism to which the internal gear 71 is fixed, the planetary gear mechanism can be of star type to which the planetary-gear supporting member 74 is fixed or of a solar type to which the sun gear 72 is fixed. The planetary gear mechanism can be used as one planetary gear mechanism by combining the planetary gear mechanism of same types or the planetary gear mechanism of different types.

If the motor 80 is arranged in the roller member 11, arranging a reduction gear in the roller member 11 is necessary.

By using such planetary gear mechanism, the reduction gear can be arranged in the roller member 11 and the copier can be downsized. In the planetary gear mechanism, an input shaft (the rotary shaft of the sun gear 72 in the first embodiment) and an output shaft (the rotary shaft of the planetary-gear supporting member 74 in the first embodiment) can be coaxially arranged, thereby, enabling to stably rotate the roller member 11.

As shown in FIG. 1, in the roller driving device 1 according to the first embodiment, a roller driving unit 90 as the surface-moving-body drive mechanism formed of the motor 80 and the gear 70 is arranged inside the roller member 11 of a cylindrical-shape. If a space surrounded by two facets 11b shown by a dotted line at each end of a width direction of the roller member 11 of the cylindrical-shape and an endless surface 11a of the roller member 11 is supposed as the roller occupying space that is the surface-moving-body occupying space, in the roller driving device 1 according to the first embodiment, the roller driving unit 90, which is the surface-moving-body drive mechanism, is arranged inside the roller occupying space.

In the roller driving device 1 according to the first embodiment, the space for arranging the roller driving unit 90 is within the roller occupying space and the space for arranging the roller driving unit 90 and the roller occupying space can be overlapped. Due to this, the roller driving unit 90 can be arranged in the shaft direction independently from the space for arranging the surface-moving-body drive mechanism and as compared to a commonly used surface-moving-body driving device shown in FIG. 8, the surface-moving-body driving device in the overlapping space can be downsized.

In the first embodiment, the roller driving unit 90 is fit inside the roller member 11 and the entire space for arranging the roller driving unit 90 is fit inside the roller occupying space. However, the present embodiment is not to be thus limited. By arranging the space for arranging the roller driving unit 90 such that at least portion of the space for arranging the roller driving unit 90 will be available in the roller occupying space, as compared to the commonly used surface-moving-body driving device shown in FIG. 8, the surface-moving-body driving device in the overlapping space can be downsized. For example, only by arranging the gear 70 inside the roller member 11, the motor 80 can be arranged towards outer side from the end of the width direction of the roller member 11. According to the first embodiment, if the entire space for arranging the roller driving unit 90 fits within the roller occupying space, the size of the roller driving device 1 can be further downsized with respect to the roller member 11.

In the roller driving device 1 shown in FIG. 1, the motor 80 is inside the roller member 11 that rotates with respect to a device main body and the motor 80 is fixed to the device main body. Electric power is supplied to the motor 80 via a main body side electrical harness 85, a connector 84, and a motor side electrical harness 86.

The connector 84 is fixed to the rear side plate 4 of the roller driving device 1. The main body side electrical harness 85 connected to a main power source on the not shown main body side is connected to the connector 84. The motor side electrical harness 86 is connected to the connector 84 and the motor side electrical harness 86 is wired inside the rear holder 8 at a position that is towards outer side from the end of the width direction of the roller member 11 and is connected to the motor 80 by passing through the rear holder 8. By performing such wiring, the electric power from the not shown main power source is supplied to the motor 80.

The present embodiment is not limited to a method mentioned earlier for supplying the electric power to the motor 80. For example, a rear side plate of the copier main body includes a main body side connector for fitting with the connector 84 and the main body side connector can be connected to the main body side main power source. In the structure mentioned earlier, if the roller driving device 1 is attachable to and detachable from the device main body, by setting the roller driving device 1 in the device main body and fitting the connector 84 and the main body side connector, the electric power can be supplied to the motor 80.

The roller driving device 1 according to the present embodiment is applicable to the roller driving device of each driving roller included in the copier. To be specific, the driving force is transmitted from the driving source to the photosensitive drum 2, the conveying rollers 47, the sheet feeding rollers 42, the separating rollers 45, the registration roller 49, the sheet feeding roller 50, the manual separating roller 52, etc. of the copier shown in FIG. 2. The roller driving device 1 is applicable to any driving roller that is rotatably driven.

If the roller driving device 1 according to the first embodiment is applied as the photosensitive drum 2, which is the roller member, the space for arranging the roller driving unit 90 is arranged such that at least portion of the space for arranging the roller driving unit 90 will be available in an area that is towards inner side from both the ends of the width direction of a photosensitive layer included on the surface of the photosensitive drum 2 of the roller occupying space.

FIG. 4 is a schematic diagram for explaining a photosensitive-element driving device 1a when the roller driving device 1 according to the first embodiment is applied to a driving device of the photosensitive drum 2.

As shown in FIG. 4, the photosensitive drum 2 includes a photosensitive layer 2a on the surface of a narrower range than the total width of the width direction. In the photosensitive-element driving device 1a shown in FIG. 4, the roller driving unit 90 is arranged in the area that is towards inner side from both the ends of the width direction of the photosensitive layer 2a in the roller occupying space of the photosensitive drum 2.

To be on the safer side, to some extent the width of the photosensitive layer 2a is set longer with respect to the transfer sheet P of a maximum width that is to be used in the copier. In other words, depending upon the size of the transfer sheet P to be used, the width of the photosensitive layer 2a is decided. When the photosensitive-element driving device 1a shown in FIG. 4 is compared with that having a length same as the length in the width direction of the photosensitive layer 2a in a commonly used photosensitive-element driving device that is the roller driving device in FIG. 8, the length in the width direction of the photosensitive-element driving device 1a can be shortened and the photosensitive-element driving device 1a can be downsized.

In the photosensitive-element driving device 1a shown in FIG. 4, even if the roller driving unit 90 fits in the roller occupying space of the photosensitive drum 2, by arranging the space for arranging the roller driving unit 90 such that a portion of the space for arranging the roller driving unit 90 will be available in the roller occupying space of the photosensitive drum 2, the photosensitive-element driving device 1a can be downsized compared to the commonly used photosensitive-element driving device.

When using various roller members other than the photosensitive drum 2, the roller driving unit 90 can be arranged such that at least portion of the roller driving unit 90 will be available in the roller occupying space that is towards inner side from both the ends of the width direction of a recording medium transition area from where the transfer sheet P of the maximum width to be used in the copier can be passed, thereby enabling to downsize the roller member compared to the roller driving device of a commonly used roller member.

Also in the photosensitive-element driving device 1a, the roller driving unit 90 is arranged such that at least potion of the roller driving unit 90 will be available in the area of the roller occupying space that is towards inner side from both the ends of the width direction of the recording medium transition area. An area α shown in FIG. 4 indicates the recording medium transition area. As shown in FIG. 4, because both the ends of the width direction of the recording medium transition area α are towards inner side from both the ends of the width direction of the photosensitive layer 2a, the structure is restricted to the structure where the roller driving unit 90 is arranged towards inner side instead of arranging towards inner side from both the ends of the width direction of the photosensitive layer 2a.

Similarly as in the photosensitive-element driving device 1a shown in FIG. 4, both the ends of a recording medium transition area of other roller members are towards inner side from both the ends of the roller member.

The roller driving device 1 includes the endless belt and a plurality of extending members extending the endless belt. At least one extending member from the plurality of extending members is applicable to the roller driving device formed of the driving roller of the belt device that is the roller member and a driving unit thereof.

When the belt device is an intermediate transfer belt unit, which is the intermediate transfer belt 10, the roller driving device 1 according to the first embodiment is applicable to the roller driving device of the first supporting roller 14, which is the driving roller. Because the roller driving device 1 is applicable to the driving device of the first supporting roller 14, the length in the width direction of the driving device of the first supporting roller 14 can be shortened compared to a commonly used driving device. Due to this, the length in the width direction of the intermediate transfer belt unit can be shortened compared to a commonly used intermediate transfer belt unit, thereby enabling to reduce the size of the intermediate transfer belt unit.

Furthermore, when the belt device is the fixing device 25, which is the fixing belt 26, the roller driving device 1 according to the first embodiment is applicable to the driving device of the driving rollers from a fixing belt supporting roller included in the fixing device 25. Because the roller driving device 1 according to the first embodiment is applicable to the driving roller of the fixing belt 26, as compared to a commonly used fixing device, the size of the fixing device 25 can be reduced.

When the belt device is the secondary transfer device, which is the secondary transfer belt 24 including a function of a recording-medium conveying belt bearing and conveying the transfer sheet P, which is the recording medium, the roller driving device 1 according to the first embodiment is applicable to the roller driving device of the secondary transfer belt extending roller 23, which is the driving roller. Because the roller driving device 1 according to the first embodiment is applicable to the secondary transfer belt extending roller 23, as compared to a commonly used secondary transfer device, the size of the secondary transfer device can be reduced.

In the embodiment mentioned earlier, four toner images on the photosensitive drums 2Y, 2M, 2C, and 2K are overlapped on the intermediate transfer belt 10 and by transferring the four toner images, a full color image is formed. Thus, in the embodiment mentioned earlier, the image forming apparatus including an intermediate transfer system transferring the full color image to the transfer sheet P is explained. However, the image forming apparatus to which the roller driving device 1 according to the first embodiment is applied is not to be thus limited. As shown in FIG. 5, a direct transfer system can also be applied in which the transfer sheet P is conveyed on a transfer conveying belt 101 and the four toner images on the photosensitive drums 2Y, 2M, 2C, and 2K are overlapped and transferred on the transfer sheet P. For example, the roller driving device 1 according to the first embodiment is applicable to the roller driving device of the first supporting roller 14, which is the driving roller of the transfer conveying belt 101. By applying the roller driving device 1 as the driving device of the first supporting roller 14, the size of the transfer conveying belt unit can be reduced.

A second embodiment of the structure, which indicates the salient features, is explained next.

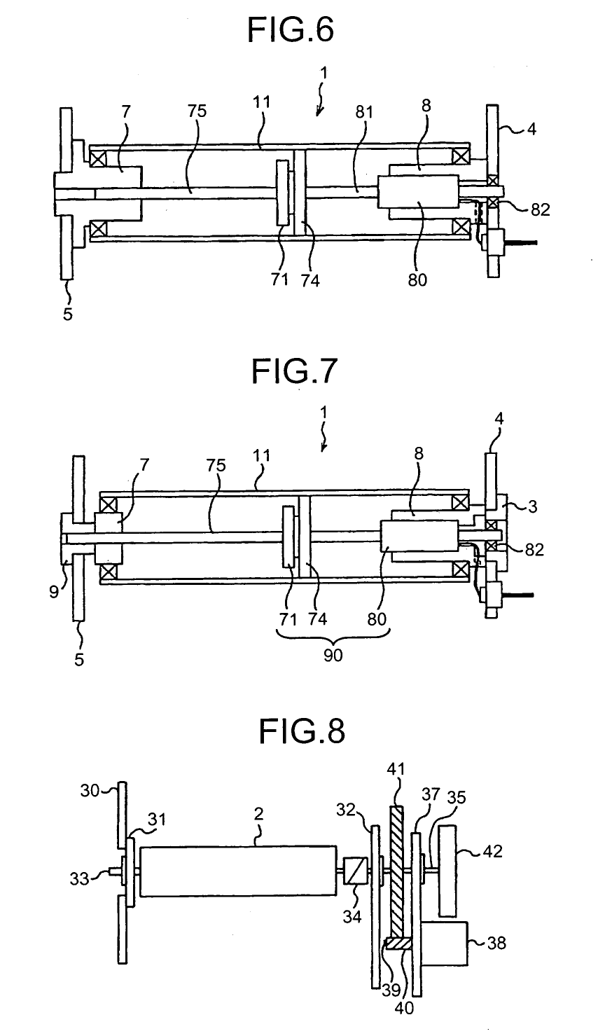

FIG. 6 is a schematic diagram for explaining the roller driving device 1 as the surface-moving-body driving device according to the second embodiment.

A basic structure of the roller driving device 1 according to the second embodiment is similar to the roller driving device 1 according to the first embodiment. A point differing from the first embodiment is that the internal gear 71 is not fixed to the rear holder 8. In the second embodiment, points common with the first embodiment are omitted and the points differing from the first embodiment are explained.

As shown in FIG. 6, the internal gear 71 is fixed to a fixed shaft 75 fixed to the front holder 7. A not shown bearing is provided at a rotation center of the internal gear 71, which is on the rear side end of the fixed shaft 75 and the front side end of the motor shaft 81 is supported by the bearing. In other words, the motor shaft 81 and the fixed shaft 75 are coaxially arranged via the not shown bearing.

The front side plate 5 supports the front side end of the motor shaft 81 via the not shown bearing, the fixed shaft 75 to which the bearing is fixed, and the front holder 7 to which the fixed shaft 75 is fixed. Furthermore, the rear side plate 4 supports the rear side end of the motor shaft 81 via the drive rotational bearing 82.

In the roller driving device 1 shown in FIG. 6, the not shown bearing, the fixed shaft 75, and the front holder 7 are front side rotary-shaft supporting members and the drive rotational bearing 82 is a rear side rotary-shaft supporting member. Using the rotary-shaft supporting members, both the ends of the motor shaft 81 are supported by the front side plate 5 and the rear side plate 4.

In the roller driving device 1 explained using FIG. 1, even if the rear side end of the motor shaft 81 is supported by the rear side plate 4, the front side end is not supported by the front side plate 5. Only both sides of the roller member 11 are supported by the front side plate 5 and the rear side plate 4.

When only both the sides of the roller member 11 are supported by the front side plate 5 and the rear side plate 4, due to parallelism between the front side plate 5 and the rear side plate 4 or mounting status of each moving-body supporting member, a central axis of the front side and the back side of the device can be out of alignment. Due to this, the rotation of the roller member is likely to be unstable.

However, as shown in the roller driving device 1 shown in FIG. 6, the front side plate 5 and the rear side plate 4 holding the roller member 11 hold a shaft including the motor shaft 81 arranged inside the roller member 11. Thus, by passing the shaft in between the front side plate 5 and the rear side plate 4 holding the roller member 11, the central shaft of the front holder 7 and the rear holder 8 holding the roller member 11 is not misaligned, thereby enabling the stable rotation.

In the roller driving device 1 of FIG. 1, only one end of the motor shaft 81 is supported by the rear side plate 4, however, in the roller driving device 1 shown in FIG. 6, both the ends of the motor shaft 81 are supported by the front side plate 5 and the rear side plate 4. As compared to the motor shaft 81 of which only one end is supported, by supporting both the ends of the motor shaft 81, misalignment of the motor shaft due to rotational driving can be avoided. Thus, a stable rotation of the roller member 11 can be implemented.

A third embodiment of the structure, which indicates the salient features, is explained next.

FIG. 7 is a schematic diagram for explaining the roller driving device 1 as the surface-moving-body driving device according to the third embodiment.

A basic structure of the roller driving device 1 according to the third embodiment is similar to the roller driving device 1 according to the second embodiment. Points differing from the second embodiment are that the moving-body supporting member supporting the front side of the roller member 11 is formed of the front holder 7 and a front fixing member 9 and the moving-body supporting member supporting the rear side of the roller member 11 is formed of the rear holder 8 and a rear fixing member 3. Points common with the second embodiment are omitted and the points differing from the second embodiment are explained.

The roller driving device 1 that is shown in FIG. 7 forms a roller unit by considering the roller member 11, the internal gear 71, the fixed shaft 75, the front holder 7, the planetary-gear supporting member 74, the motor shaft 81, the motor 80, and the rear holder 8 as a unit. The roller unit is fixed to the front side plate 5 and the rear side plate 4 by using the front fixing member 9 and the rear fixing member 3. The roller unit can be removed from the device by removing the front fixing member 9 and the rear fixing member 3. The roller member 11 and the roller driving unit 90 are integrally attachable to and detachable from the front side plate 5 and the rear side plate 4. Thus, replacement of the roller member 11 or maintenance of the roller driving device 1 can be easily carried out.

In the commonly used surface-moving-body driving device shown in FIG. 8, the surface moving body and the driving unit are arranged by sandwiching therebetween, side plates 32 and 37 that are fixed to the surface-moving-body driving device main body. Thus, replacing the roller is very difficult. However, in the roller driving device 1 shown in FIG. 6, because the roller member 11 and the roller driving unit 90 are arranged between the front side plate 5 and the rear side plate 4, the roller can be replaced only by removing two fixing members. Due to this, the replacement and the maintenance of the roller can be easily carried out, thereby enabling to lengthen the life of the main body.

According to the present embodiments mentioned earlier, the roller member 11, which is the surface moving body, the motor 80, which is the driving source of the roller member 11, and the roller driving unit 90, which is the surface-moving-body drive mechanism formed of the gear 70, which is the drive transmission mechanism transmitting the driving force from the motor 80 to the roller member 11, are included. In the roller driving device 1, which is the surface-moving-body driving device used in the image forming apparatus, the space for arranging the roller driving unit 90 is within the roller occupying space, which is the surface body moving occupying space surrounded by the two facets 11b and the endless surface 11a of the roller member 11, and the space for arranging the roller driving unit 90 and the roller occupying space can be overlapped. Thus, as compared to the commonly used surface-moving-body driving device to be arranged in the shaft direction independently from the space for arranging the surface-moving-body drive mechanism, the roller driving device 1, which is the surface-moving-body driving device, can be downsized in the overlapping space.

The gear 70, which is the drive transmission mechanism, is the planetary gear mechanism and is arranged in the roller occupying space. Due to this, the reduction gear can be arranged in the roller member 11 and the roller driving device 1 can be downsized. In the planetary gear mechanism, because the input shaft and the output shaft can be coaxially arranged, the roller member 11 can be stably rotated.

In the roller driving device 1 according to the second embodiment, the motor shaft 81, which is a driving rotary shaft, is supported by the rear side plate 4 and the front side plate 5 via each rotary-shaft supporting member, thereby enabling to stabilize the rotation of the motor shaft 81 and also the rotation of the roller member 11.

The roller driving device 1 according to the third embodiment includes the rear side plate 4 and the front side plate 5 supporting the roller member 11 at both the ends of the width direction via each moving-body supporting member. The roller member 11 and the roller driving unit 90 are arranged between the rear side plate 4 and the front side plate 5. As the roller unit, the roller member 11 and the roller driving unit 90 are integrally attachable to and detachable from the rear side plate 4 and the front side plate 5. Due to this, replacement of the roller member 11 and the maintenance of the roller driving device 1 can be easily carried out.

By applying the roller driving device 1 according to the first embodiment to the photosensitive-element driving device 1a, which is the surface-moving-body driving device of the photosensitive drum 2, which is the photosensitive element including the photosensitive layer 2a, the photosensitive-element driving device 1a can be downsized.

By arranging the roller driving unit 90 in the area that is towards inner side from both the ends of the width direction of the photosensitive layer 2a in the roller occupying space of the photosensitive drum 2, if the length in the width direction of the photosensitive layer 2a is compared with the commonly used photosensitive-element driving device having the same length in the width direction, the length in the width direction of the photosensitive-element driving device 1a can be shortened and the photosensitive-element driving device 1a can be downsized.

The roller driving unit 90 is arranged in the roller occupying space that is towards inner side from both the ends of the width direction of the recording medium transition area α that is towards inner side from the width direction of the photosensitive layer 2a. Due to this, the length in the width direction of the photosensitive-element driving device 1a can be shortened compared to the length of the commonly used photosensitive-element driving device that includes the recording medium transition area of the same length. Thus, the photosensitive-element driving device 1a can be downsized.

Without limiting to the photosensitive drum 2, even if another roller member is used as the roller member 11, by arranging the roller driving unit 90 in the roller occupying space that is within both the ends of the width direction of the recording medium transition area α, as compared to the roller driving device of the commonly used roller member, the roller member 11 can be downsized.

By applying the roller driving device 1 according to the first embodiment to the roller driving device of a recording-medium conveying roller such as the conveying rollers 47, the roller driving device 1 including the recording-medium conveying roller can be downsized.

By applying the roller driving device 1 according to the first embodiment to the driving roller of the intermediate transfer belt unit, which is the belt device including the intermediate transfer belt 10 and the driving device, the intermediate transfer belt unit can be downsized.

As indicated in the modifications, by applying the roller driving device 1 according to the first embodiment to the driving roller of the transfer conveying belt unit, which is the belt device including the transfer conveying belt 101, and the driving device, the transfer conveying belt unit can be downsized.

By arranging the roller driving unit 90 such that at least portion of the roller driving unit 90 will be available inside the width direction of the recording medium transition area α of the belt device, a space required for the driving unit of the belt device can be reduced and the belt device can be downsized.

By applying the roller driving device 1 according to the first embodiment to at least one driving unit of the driving roller included in the copier, which is the image forming apparatus, the copier can be downsized.

In the structure including the roller unit, which is a surface-moving-body replacing unit by which the roller member 11 is attachable to and detachable from the copier, if the roller unit includes the roller driving unit 90 as indicated in the third embodiment, the replacement of the roller member 11 and the maintenance of the roller driving device 1 can be easily carried out.

In the copier that includes the belt device such as the intermediate transfer unit when the roller driving device 1 according to the first embodiment is applied as the driving unit of the driving roller, the belt device can be downsized, thereby enabling to downsize the entire device.

When the roller unit, which is attachable to and detachable from the copier including the belt device when the roller driving device 1 according to the first embodiment is applied as the driving unit of the driving roller, includes the roller driving unit and the endless belt, the replacement of the endless belt of the roller member 11 or the maintenance of the roller driving device 1 or the belt device can be easily carried out.

As described above, according to an embodiment of the present invention, because a surface-moving-body occupying space and a space for arranging a surface-moving-body drive mechanism can be at least partially overlapped, as compared to a commonly used surface-moving-body driving device to be arranged in a shaft direction independently from the surface-moving-body occupying space and the space for arranging the surface-moving-body drive mechanism, a size of a surface-moving-body driving device with respect to a surface moving body in an overlapping space can be downsized.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A surface-moving-body driving device that is used in an image forming apparatus, the surface-moving-body driving device comprising:
a surface moving body including an endless surface that is capable of making an endless movement; and
a surface-moving-body drive mechanism including
a driving source of a driving force for moving the surface moving body, and
a drive transmission mechanism for transmitting the driving force from the driving source to the surface moving body, wherein
at least a part of the surface-moving-body drive mechanism is arranged in a surface-moving-body occupying space surrounded by two surfaces defined by both ends of the endless surface in a width direction orthogonal to a surface moving direction of the endless surface and the endless surface.

2. The surface-moving-body driving device according to claim 1, wherein the drive transmission mechanism includes a planetary gear mechanism that is arranged inside the surface-moving-body occupying space.

3. The surface-moving-body driving device according to claim 1, further comprising two side plates supporting the ends of the endless surface in the width direction via a moving-body supporting member, wherein
the driving source includes a driving rotary shaft for externally transmitting the driving force,
a shaft direction of the driving rotary shaft is parallel to the width direction, and
the driving rotary shaft is supported by the two side plates via a rotary-shaft supporting member.

4. The surface-moving-body driving device according to claim 1, further comprising two side plates supporting the ends of the endless surface in the width direction via a moving-body supporting member, wherein
the surface moving body and the surface-moving-body drive mechanism are arranged between two side plates, and
the surface moving body and the surface-moving-body drive mechanism are integrally arranged in a detachable manner with respect to the two side plates.

5. The surface-moving-body driving device according to claim 1, wherein the surface moving body is a photosensitive element including a photosensitive layer on its surface.

6. The surface-moving-body driving device according to claim 1, wherein the surface moving body is a recording-medium conveying roller for conveying a recording medium.

7. The surface-moving-body driving device according to claim 5, wherein at least a part of the surface-moving-body drive mechanism is arranged in an area inside both ends of the photosensitive layer in the surface-moving-body occupying space in the width direction.

8. The surface-moving-body driving device according to claim 5, wherein at least a part of the surface-moving-body drive mechanism is arranged in an area inside both the ends of a recording medium transition area through which a recording medium of a maximum width used in an image forming apparatus employing the surface-moving-body driving device can pass in the surface-moving-body occupying space in the width direction.

9. The surface-moving-body driving device according to claim 6, wherein at least a part of the surface-moving-body drive mechanism is arranged in an area inside both the ends of a recording medium transition area through which a recording medium of a maximum width used in an image forming apparatus employing the surface-moving-body driving device can pass in the surface-moving-body occupying space in the width direction.

10. An image forming apparatus that forms an image on a recording medium, the image forming apparatus including a surface-moving-body driving device including a surface moving body, wherein
at least one surface-moving-body driving device is the surface-moving-body driving device according to claim 1.

11. The image forming apparatus according to claim 10 further comprising a surface-moving-body replacing unit that is integrally arranged with the surface moving body in a detachable manner with respect to a main body of the image forming apparatus, wherein
the surface-moving-body replacing unit includes the surface-moving-body drive mechanism.

12. A belt device comprising:
an endless belt; and
a plurality of extending members extending the endless belt, wherein
at least one extending member is a surface moving body of a surface-moving-body driving device,
at least one surface-moving-body driving device includes
a surface moving body including an endless surface that is capable of making an endless movement, and
a surface-moving-body drive mechanism including a driving source of a driving force for moving the surface moving body and a drive transmission mechanism for transmitting the driving force from the driving source to the surface moving body, and
at least a part of the surface-moving-body drive mechanism is arranged in a surface-moving-body occupying space surrounded by two surfaces defined by both ends of the endless surface in a width direction orthogonal to a surface moving direction of the endless surface and the endless surface.

13. The belt device according to claim 12, wherein
the endless belt is an intermediate transfer belt on which a toner image is primarily transferred from an image carrier by a primary transfer unit, and
the toner image that is primarily transferred from the image carrier is conveyed by the endless moving, and secondarily transferred to a recording medium or another image carrier by a secondary transfer unit.

14. The belt device according to claim 12, wherein the endless belt is a recording-medium conveying belt for conveying a recording medium.

15. The belt device according to claim 12, wherein at least a part of the surface-moving-body drive mechanism is arranged in an area inside both the ends of a recording medium transition area through which a recording medium of a maximum width used in an image forming apparatus employing the surface-moving-body driving device can pass in the surface-moving-body occupying space in the width direction.

16. An image forming apparatus that forms an image on a recording medium, the image forming apparatus comprising a belt device according to claim 12.

17. The image forming apparatus according to claim 16, further comprising a surface-moving-body replacing unit that is integrally arranged with the surface moving body in a detachable manner with respect to a main body of the image forming apparatus, wherein
the surface-moving-body replacing unit includes the surface-moving-body drive mechanism and the endless belt.
